(19) United States
(12) Patent Application Publication
(10) Pub. No.: US 2008/0275926 A1
(43) Pub. Date: Nov. 6, 2008

(54) STORAGE SYSTEM AND METHOD OF COPYING DATA

(75) Inventors: Manabu Kitamura, Tokyo (JP); Naoto Matsunami, Tokyo (JP); Koji Sonoda, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/166,231

(22) Filed: Jul. 1, 2008

Related U.S. Application Data
(63) Continuation of application No. 10/245,887, filed on Sep. 16, 2002.

(30) Foreign Application Priority Data
Feb. 26, 2002 (JP) 2002-049540

(51) Int. Cl. G06F 12/16; G06F 17/30

(52) U.S. Cl. 707/204; 707/E17.01; 711/E12.103

(57) ABSTRACT

A storage system comprises a primary storage system comprising a primary storage apparatus and a primary control apparatus for controlling the primary storage apparatus; and a secondary storage system comprising a secondary storage apparatus and secondary control apparatus for controlling the secondary storage apparatus. The primary storage apparatus and the secondary storage apparatus are connected to each other via a communication line. The primary storage system sends, to the primary storage apparatus, a data-transfer instruction instructing the primary storage apparatus to transfer predetermined data stored in the primary storage apparatus to the secondary storage system. The primary storage apparatus receives the data-transfer instruction, reads out the predetermined data from the primary storage apparatus, and sends the data via the communication line to the secondary storage apparatus of the secondary storage system.

### CROSS-REFERENCES TO RELATED APPLICATIONS

The present application is a continuation of U.S. application Ser. No. 10/245,887, filed Sep. 16, 2002, entitled “Storage System and method of Copying Data,” (Attorney Docket No. 16869K-059700US), which claims benefit from Japanese Patent Application No. 2002-49540 filed on Feb. 26, 2002, the entire contents of which are herein incorporated by reference for all purposes.

### BACKGROUND OF THE INVENTION

The present invention relates to a storage system, a primary storage system, a secondary storage system and a data-copying method used therefore.

### DESCRIPTION OF THE RELATED ART

RAID (Redundant Arrays of Inexpensive Disks, or Redundant Arrays of Independent Disks) is known as one technology for improving reliability of data held in storage resources such as magnetic disks. Further, in order to avoid data loss which may occur due to disasters such as fires or earthquakes, data may be held in a duplicate manner among a plurality of storage apparatuses provided, for example, at remote locations. As a method for preventing data loss, there is known a method referred as “remote duplication”.

Remote duplication is a method for storing a data copy among a plurality of subsystems. A host computer (or an external computer) is connected to a storage system comprising a primary storage system and a secondary storage system. Respective servers of the primary storage system and the secondary storage system are mutually connected to each other and also connected to the host computer via a network such as, for example, a LAN (Local Area Network) or a WAN (Wide Area Network). Data of the primary storage system is copied to the secondary storage system via these servers and thus the network such as the LAN or WAN.

Specifically exemplifying, firstly, the host computer issues a write request to the primary storage system. The primary storage system stores the data received from the host computer in a storage apparatus within its own system. Then, the primary storage system transfers the stored data to the secondary storage system. The secondary storage system stores the data received from the primary storage system in a storage apparatus within its own system.

Accordingly, the data sent from the host computer to the primary storage system is stored in the storage apparatuses of both the primary storage system and the secondary storage system. Thus, in the whole storage system, data is multiplexed among both the primary storage system and the secondary storage system every time a write request is received from the host computer. Therefore, the storage system can restore the latest data from the secondary storage system as required.

However, upon copying the data of the primary storage system to the secondary storage system, copying is carried out via the respective servers of the primary storage system and the secondary storage system and also via a network such as a LAN or a WAN. Accordingly, a process in which each of the servers read out the data from the storage apparatuses becomes necessary; and thus, speeding up of the copying process cannot be realized. Additionally, since the copying process is carried out using the network, such as the LAN or WAN, to which the host computer is connected, if the server is performing any other process, the copying process may not be performed immediately, which may lead to delay in the copying process. Further, from the server's point of view, data transferring will increase the workload of the server.

### SUMMARY OF THE INVENTION

The present invention has been contrived in view of the above and other problems, and one object is to provide a storage system, a primary storage system, a secondary storage system, and a data-copying method used therefor.

In order to achieve the above and other objects, one aspect of the present invention is a storage system comprising: a primary storage system comprising a primary storage apparatus and a primary control apparatus for controlling the primary storage apparatus; and a secondary storage system comprising a secondary storage apparatus and a secondary control apparatus for controlling the secondary storage apparatus. The primary storage apparatus and the secondary storage apparatus are connected to each other via a communication line. The primary storage apparatus of the primary storage system comprises primary remote-copying means, and the secondary storage apparatus of the secondary storage system comprises secondary remote-copying means, and the primary control apparatus of the primary storage system comprises remote-copy controlling means for controlling the primary remote-copying means. The remote-copy controlling means sends, to the primary remote-copying means of the primary storage apparatus, a data-transfer instruction instructing the primary remote-copying means to transfer predetermined data stored in the primary storage apparatus to the secondary storage system; the primary remote-copying means receives the data-transfer instruction, reads out the predetermined data from the primary storage apparatus, and sends the data to the secondary remote-copying means of the secondary storage system via the communication line; and the secondary remote-copying means receives the predetermined data and stores the received data in the secondary storage apparatus.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a block diagram showing an example of a structure of a storage system according to a first embodiment of the present invention;

FIG. 2 is a data-structure diagram showing a structure of a file system of a magnetic disk device in a storage system according to an embodiment of the present invention;

FIG. 3 is a data-structure diagram showing a structure of a remote-copying command issued from a remote-copy controller of a file server in a local-file server to a remote-copying means of a storage device in a storage system according to an embodiment of the present invention;

FIG. 4 is a data-structure diagram showing differential information recorded on a control memory of a remote-copy controller 114 of a local-file server in a storage system according to an embodiment of the present invention;

FIG. 5 is a flowchart showing an initial copying process performed by a storage system according to an embodiment of the present invention;

FIG. 6 is a flowchart showing a differential copying process performed by a storage system according to an embodiment of the 10 present invention;

FIG. 7 is a block diagram showing an example of a structure of a storage system according to a second embodiment of the present invention;

FIG. 8 is a conceptual diagram showing structures of files and directories and a state in which the destination of copying is distributed in a storage system according to a second embodiment of the present invention;

FIG. 9 is a block diagram showing an example of a structure of a storage system according to a third embodiment of the present invention; and

FIG. 10 is a conceptual diagram showing an initial copying process in a storage system according to a third embodiment of the present invention.

### DETAILED DESCRIPTION OF THE INVENTION

At least the following matters will be made clear by the explanation in the present specification and the description of the accompanying drawings.

According to one aspect of the present invention, a storage system comprises: at least two storage subsystems respectively comprising a storage apparatus and a control apparatus for controlling the storage apparatus. The storage apparatuses of each of the storage subsystems are connected to each other via a communication line. Each of the storage apparatuses of each of the storage subsystems respectively comprise copying means, and the control apparatus of at least one of the storage subsystems comprises a copy controlling means for controlling the copying means provided within the same storage subsystem as the copy controlling means. The copy controlling means sends, to the copying means of the storage apparatus within the same storage subsystem, a data-transfer instruction instructing the copying means to transfer predetermined data stored in the storage apparatus within the same storage subsystem to another the storage subsystem connected via the communication line; the copying means receives the data-transfer instruction, reads out the predetermined data from the storage apparatus within the same storage subsystem, and sends the data to another one of the copying means of the another storage subsystem via the communication line; and the another copying means receives the predetermined data and stores the received data in the storage apparatus of the another storage subsystem.

According to such an aspect of the present invention, for example, speed up of data transferring between the primary storage system and the secondary storage system can be realized.

Now, storage systems according to first through third embodiments of the present invention will be explained with reference to the drawings.

### FIRST EMBODIMENT

### <<Example of Overall Structure>>

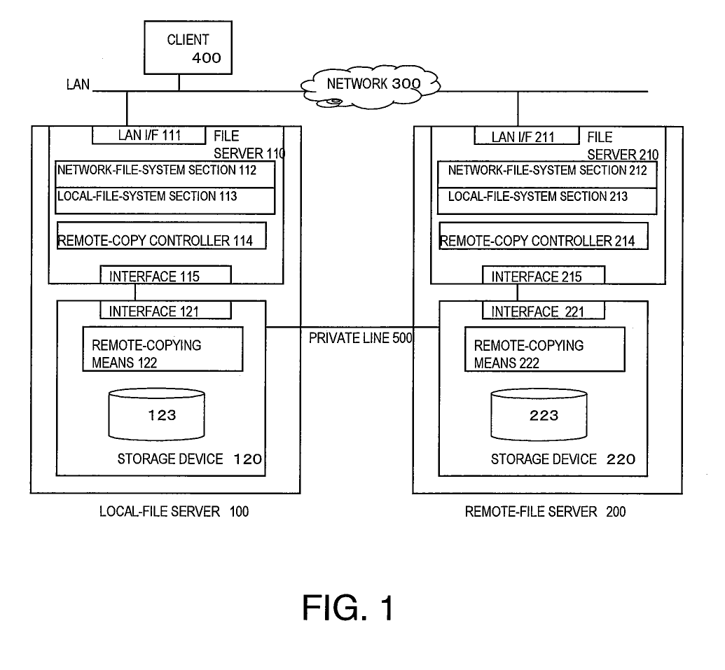

Firstly, a storage system of the first embodiment will be explained. As shown in the block diagram of FIG. 1, the system comprises a local-file server (primary storage system) 100 and a remote-file server (secondary storage system) 200. There may be cases where a plurality of remote-file servers 200 exist for one local-file server 100. Each of the servers 100, 200 are referred to as a NAS (Network Attached Storage), and respectively comprise file servers (control apparatuses) 110, 210 and storage devices (storage apparatuses) 120, 220.

The file servers 110, 210 are connected to a network 300 such as a LAN or a WAN respectively via appropriate communication interfaces 111, 211 such as LAN interfaces. A client (i.e., host computer or external computer) 400 is also connected to the network 300. Data is sent from the client 400 to the file server 110 of the local-file server 100 via the network 300. The file server 110 hands over or transfers the received data to the storage device 120.

Further, the storage device 120 of the local-file server 20 100 and the storage device 220 of the remote-file server 200 are mutually connected to each other by a private line (communication line) such as Fibre Channel 500.

The file server 110 of the local-file server 100 may be configured of, as a hardware configuration: a control processor for controlling the overall operations of the file server 110; a control memory for storing programs executed by the control processor and/or data; and a buffer for temporarily storing data. The file server 110 of the local-file server 100 comprises: a network-file-system section 112; a local-file-system section 30 113; a remote-copy controller 114; and an interface 115. The network-file-system section 112 comprises a function of performing data-communication processes with the client 400. The local-file-system section 113 comprises a function of performing a process of transferring data sent from the client 400 to the storage device 120 via the interface 115.

The remote-file server 200 comprises substantially the same configuration and functions as the above-mentioned local-file server 100. That is, the file server 210 comprises: a network-file-system section 212; a local-file-system section 213; a remote-copy controller 214; and an interface 215. The network-file-system section 212 comprises a function of performing data-communication processes with the client 400. The local-file-system section 213 comprises a function of performing a process of transferring data sent from the client 400 to the storage device 220 via the interface 215.

The remote-copy controller 114 of the local-file server 100 controls remote-copying means 122 in the storage device 120. Specifically, the remote-copy controller 114 issues, to the storage device 120 via the interface 115, a data-transfer instruction requesting to copy the data stored in the storage device 120 to the remote-file server 200.

Each of the storage devices 120, 220 respectively comprises: an interface 121, 221; a remote-copying means 112, 222; and a magnetic disk device 123, 223.

Each of the remote-copying means 122, 222 of the storage devices 120, 220 may respectively be configured of, as a hardware configuration: a control processor for controlling the overall operations of the remote-copying means; a control memory for storing programs executed by the control processor and/or data; and a buffer for temporarily storing data. The remote-copying means 122 of the local-file server 100 receives the data-transfer instruction from the remote-copy controller 114 of the file server 110 via the interface 121. Having received the data-transfer instruction, the remote-copying means 122 reads out data from the magnetic disk device 123 and transfers the data to the storage device 220 of the remote-file server 200 via the private line 500.

The remote-copying means 222 of the storage device 220 of the remote-file server 200 receives the data transferred from the local-file server 100, and stores the data in the magnetic disk device 223.

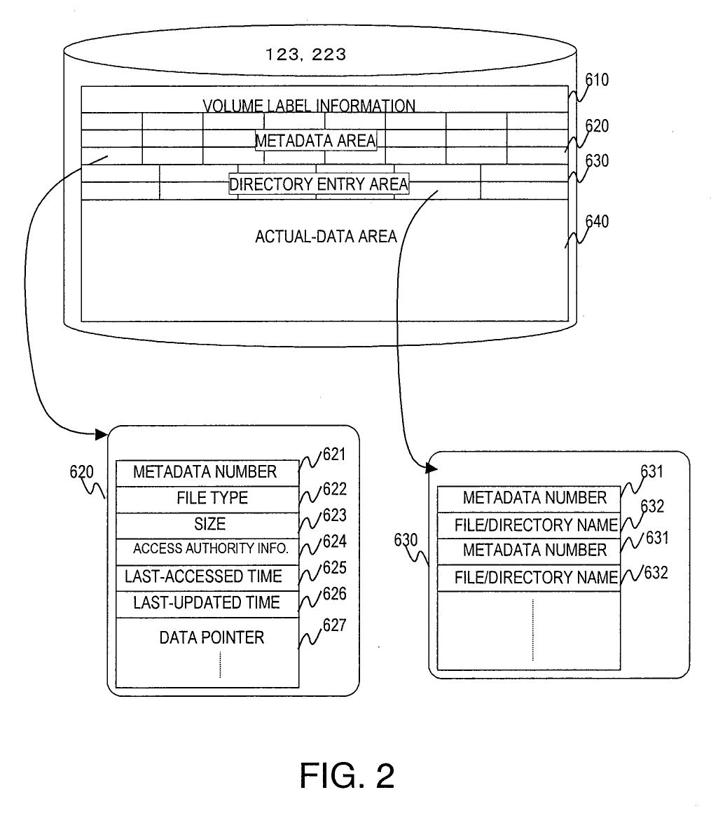

The structure of a file system of the respective magnetic disk devices 123, 223 will be explained with reference to the data-structure diagram in FIG. 2. As shown in FIG. 2, the file system comprises: an area for data-management information comprising volume label information 610, a metadata area 620, and a directory entry area 630; and an actual-data area 640. The metadata area 620 comprises: a metadata number 621; file type 622; size 623; information on access authority 624; last-accessed time 625; last-updated time 626; and a plurality of data pointers 627. The directory entry area 630 comprises a plurality of combinations of a metadata number 631 and a file/directory name 632.

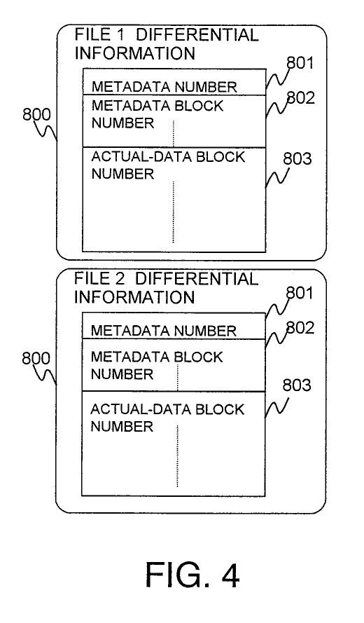

With reference to the data-structure diagram in FIG. 4, explanation will be made of differential information (i.e., information relating to updated data) which is read out from the control memory and used by the remote-copy controller 114 in the local-file server 100. The differential information is recorded as differential information when updating of a file is instructed by the client 400 to the local-file server 100 and updated data is stored to the storage device 120 during the remote copying process. The differential information is used by the remote-copy controller 114 when instructing remote copying to the remote-copying means 122 in a differential copying process described later. As shown in FIG. 4, file differential information 800 is created respectively for each files 1, 2 . . . by the local-file-system section 113. Each file differential information 800 comprises a metadata number 801, a plurality of metadata block numbers 802, and a plurality of actual-data block numbers 803.

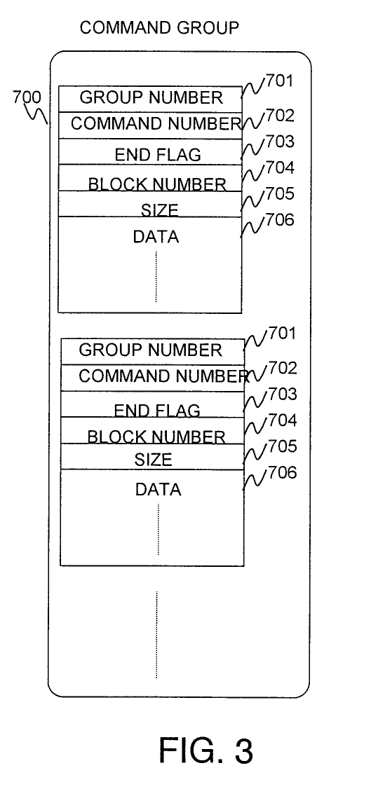

Next, with reference to FIG. 3, explanation will be made of a structure of a remote-copying command which is issued by the remote-copying means 122 of the storage device 120 in the local-file server 100 to the storage device 220 in the remote-file server 200. As shown in FIG. 3, in the remote-copying command 700, a plurality of commands are grouped. Each of the commands 700 comprises: a group number 701; a command number 702; an end flag 703; a block number 704; size 705; and data (i.e., continuous actual data) 706.

Upon a copying process for one file, the remote-copy controller 114 hands (or transfers) the differential information shown in FIG. 4 to the remote-copying means 122. According to this differential information, the remote-copying means 122 creates one or a plurality of commands to which a same group number 701 is assigned. The remote-copying means 222 in the storage device 220 carries out writing-in of the received series of commands to the magnetic disk device 223 on a group-by-group basis of commands having the same group number 701.

Specifically, when a plurality of commands having the same group number 701 is received, the remote-copying means 222 does not carry out write-in to the magnetic disk device 223 until all of the commands having the same group number 701 arrive. When all of the commands having the same group number 701 arrive to the remote-copying means 222, the means 222 carries out write-in to the magnetic disk device 223. The above-mentioned arrival of all commands can be determined by checking whether all commands, i.e., from the command having the smallest command number 702 to the command in which the end flag 703 is ON, have all arrived. Accordingly, it is possible to prevent writing-in, to the storage device 220 of the remote-file server 200, of a file in an incomplete state.

### <<Remote-Copying Process>>

Next, explanation will be made of the remote-copying process carried out by the storage system according to the present embodiment. In the remote-copying process, firstly, an initial copying process is carried out. This initial copying process is such where data of files and/or directories already written in to the local-file server 100 is all copied to the remote-file server 200. Then, a differential copying process is subsequently carried out. In this differential copying process, data of files and/or directories, for which updating has been instructed by the client 400 to the local-file server 100, is copied to the remote-file server 200.

### —Initial Copying—

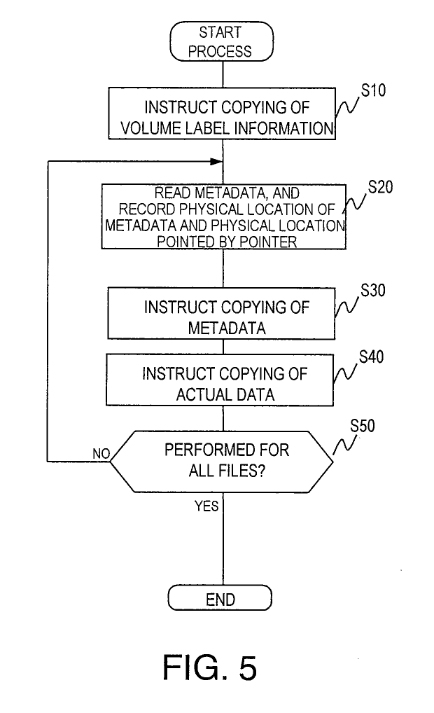

Firstly, explanation will be made of the initial copying process according to the present embodiment with reference to the 25 flowchart in FIG. 5.

After starting of the process, the remote-copy controller 114 (see FIG. 1) of the local-file server 100 instructs the remote-copying means 122 (see FIG. 1) of the storage device 120 to copy the volume label information 610 (see FIG. 2) (S10). Then, the remote-copy controller 114 instructs the local-file-system section 113 to read out the metadata 620. The local-file-system section 113 notifies, to the remote-copy controller 114, the physical location of the metadata 620 and the physical location pointed by the data pointer 627 (see FIG. 2). The remote-copy controller 114 records the notified physical locations (S20).

Next, the remote-copy controller 114 instructs the remote-copying means 122 to copy the metadata 620 (S30). The remote-copying means 122 sends, to the remote-copying means 222 of the storage device 220 of the remote-file server 200, a command group shown for example in FIG. 3 via the private line 500 (see FIG. 1). The remote-copying means 222 obtains data from the sent command group and stores the data in the magnetic disk device 223 (see FIG. 1).

Then, the remote-copy controller 114 instructs the remote-copying means 122 to copy the actual-data 640 (S40). The copy operation is done file by file. The remote-copy controller 114 gets the physical location of a file using the local-file-system section 113. The remote-copying means 122 sends, to the remote-copying means 222 of the remote-file server 200, a command group shown, for example, in FIG. 3 via the private line 500. The remote-copying means 222 obtains data from the sent command group and stores the data in the magnetic disk device 223.

Then, the remote-copy controller 114 confirms whether copying to the magnetic disk device 223 of the storage device 220 of the remote-file server 200 has been performed or not for all of the data files in the magnetic disk device 123 (see FIG. 1) of the storage device 120 of the local-file server 100 (S50). As a result of this confirmation, if copying of all of the data files is finished, the initial copying is ended (S50: YES-> END). If copying of all data files is not finished (S50: NO), the process from the above-mentioned S20 is performed.

By executing the copy operation in each file instead of copying the entire data in the storage device 120, the workload of the remote-copying means 122 and 222 are reduced. Suppose the size of magnetic disk device 123 is 1 gigabytes and there is only one small file whose size is 1 kilobytes in the storage device 120. If the remote-copying means 122 has to copy the entire data of the magnetic disk device 123 in the initial copy, 1 gigabytes of data has to be transferred via private line 500. By executing the copy operation in each file, the remote-copying means 122 can only copy 1 kilobytes of data.

### —Differential Copying—

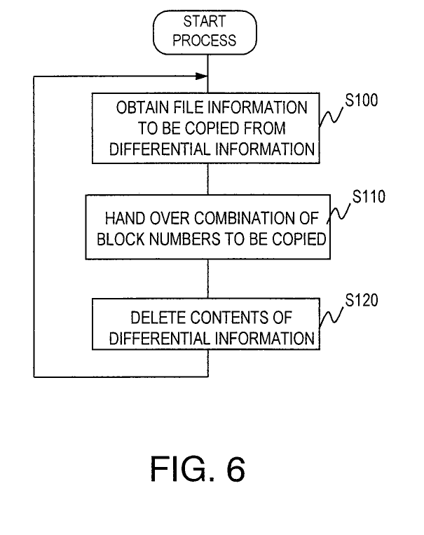

Next, explanation will be made of the above-mentioned differential copying process by the storage system with reference to the flowchart in FIG. 6. This process may be executed each time after the local-file server 100 stores updated data to the storage device 120. Or it may be executed independently of the update of the data storage device 120, for example, it may be executed after a plurality of file update requests from the client 400 are processed.

After starting of the process, the remote-copy controller 114 of the local-file server 100 (FIG. 1) obtains, from the control memory, file information to be copied based on the above-mentioned differential information 800 shown in FIG. 4 (S100).

Then, the remote-copy controller 114 notifies the combination of block numbers 802, 803 (see FIG. 4) obtained from the obtained file information to the remote-copying means 122 of the storage device 120 (S110). Based on the combination of block numbers 802, 803 notified, the remote-copying means 122 reads out the data corresponding to the block numbers from the magnetic disk device 123 (see FIG. 1), and creates a command group shown for example in FIG. 3.

Then, the remote-copying means 122 sends, to the remote-copying means 222 of the storage device 220 of the remote-file server 200, the created command group via the private line 500 (see FIG. 1), and the remote copy controller 114 deletes the differential information corresponding to the data in which copying has finished (S120). The remote-copying means 222 obtains data from the command group having been sent, and stores the data in the magnetic disk device 223 (see FIG. 1). The differential information is accumulated each time there is file updating in the local-file server 100. Thus, by repeating the process shown in FIG. 6, remote duplication can be realized in the storage system of the present embodiment.

### SECOND EMBODIMENT

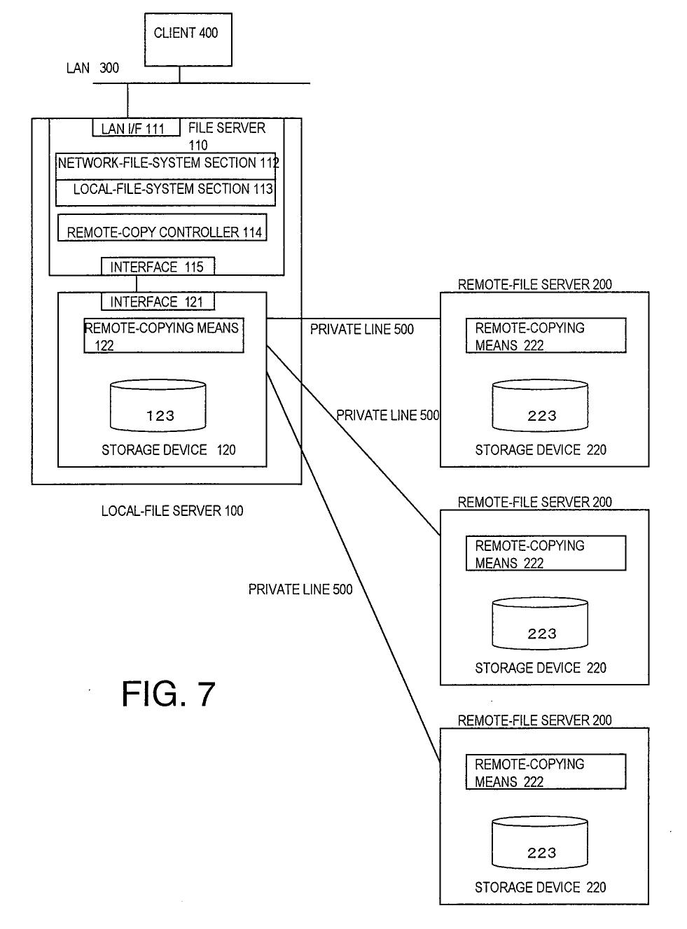

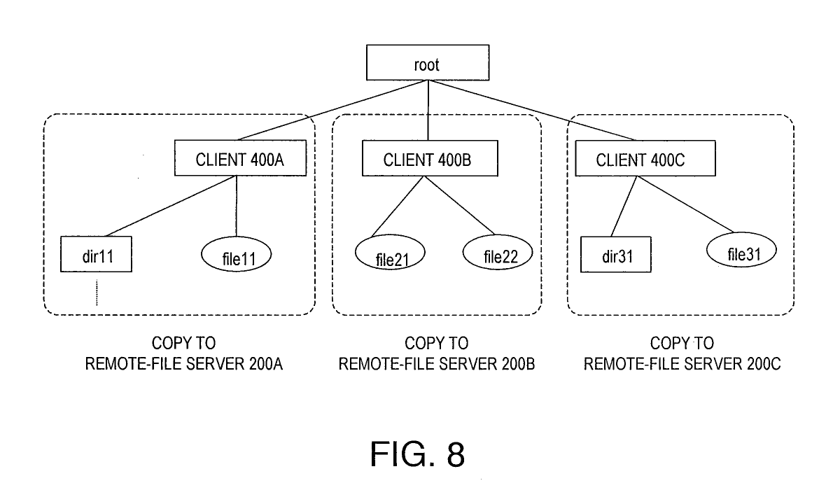

Next, explanation will be made of a storage system according to a second embodiment with reference to FIG. 7 and FIG. 8. The present embodiment is a modified example of the above-mentioned first embodiment shown in FIG. 1. Explanation of the above-mentioned storage system and other overlapping matters common to both embodiments will not be repeated, and explanation will be made mainly of matters different among the embodiments. As can be seen in FIG. 7, in the present embodiment, a plurality of remote-file servers 200 are connected, in parallel via the respective private lines 500, to one local-file server 100.

The data in one local-file server 100 may be multiplexed and stored in an overlapping manner respectively in each of the remote-file servers 200; or the data in one local-file server 100 may be divided, and distributed data may respectively be sent to allocated ones of each of the remote-file servers 200. An example of this distributed copying is shown in a conceptual diagram of FIG. 8 showing structures of files and directories and a state in which the destination of copying is distributed. In this example, directories 11, 31 and files 11, 21, 22, 31 for exclusive use of each clients 400A, 400B and 400C are assigned and copied respectively to the remote-file servers 200A, 200B and 200C in view of a ROOT directory. That is, data of the directory 11 and file 11 for the client 400A, is copied from the local-file server 100 to the remote-file server 200A; data of the files 21, 22 for the client 400B is copied from the local-file server 100 to the remote-file server 200B; and data of the directory 31 and file 31 for the client 400C is copied from the local-file server 100 to the remote-file server 200C. The copying method is substantially the same as that of the above-mentioned first embodiment, and the initial copying process and the differential copying process are carried out.

### THIRD EMBODIMENT

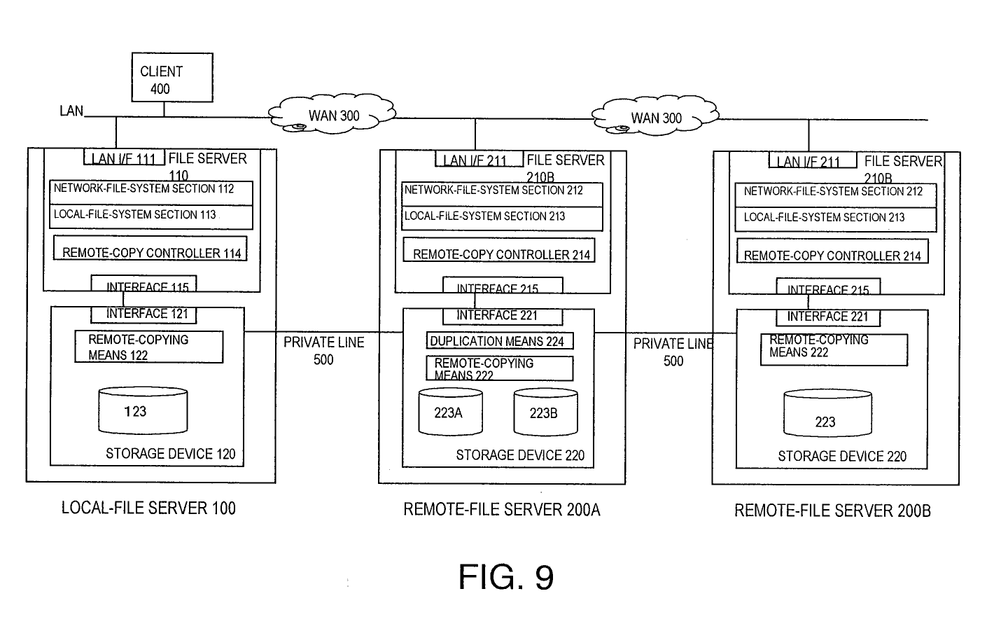

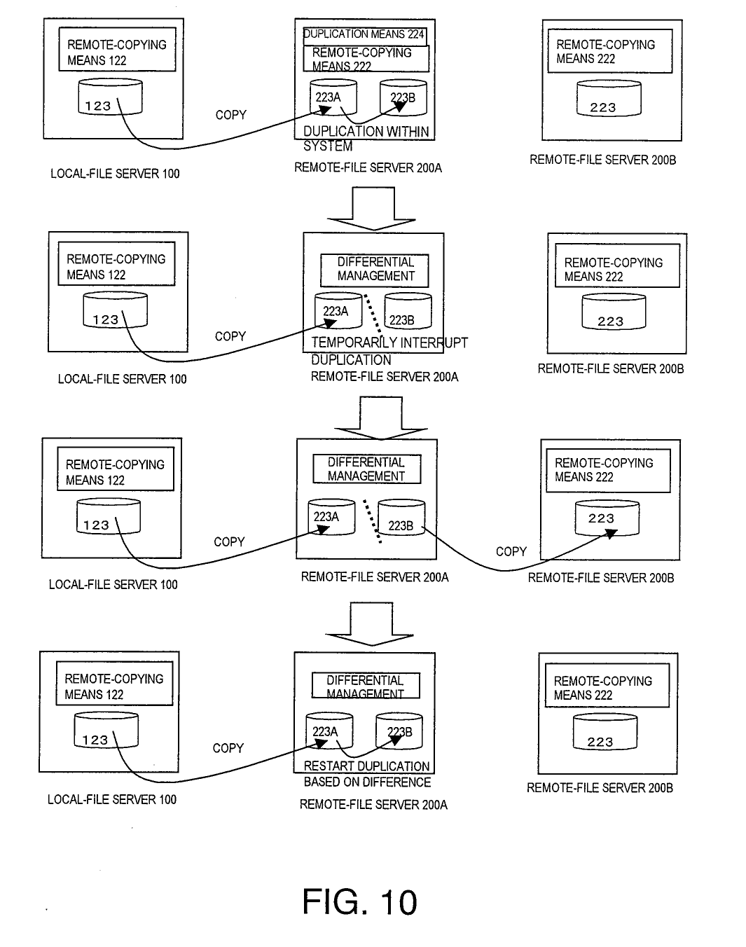

Next, explanation will be made of a storage system according to a third embodiment with reference to FIG. 9 and FIG. 10. The present embodiment is a modified example of the above-mentioned first embodiment shown in FIG. 1. Explanation of the above-mentioned storage system and other overlapping matters common to both embodiments will not be repeated, and explanation will be made mainly of matters different among the embodiments. As can be seen in FIG. 9, in the present embodiment, a plurality of remote-file servers 200A, 200B are hierarchically connected, in series via respective private lines 500, to one local-file server 100.

The storage device 220 of the remote-file server 200A 30 connected directly to the local-file server 100 comprises duplication means 224 therein. Further, the magnetic disk devices (storage means) 223A, 223B of the storage device 220 are paired (in a combination) for duplication. The remote-file server 200B is connected to the remote-file server 200A via the private line 500. The remote-file server 200B is substantially the same as the above-mentioned remote-file server 200 shown in FIG. 1.

A method of a copying process according to the above-described storage system will be explained. A conceptual diagram of the method is shown in FIG. 10. Firstly, in STEP1000, a copying process is carried out in a regular manner between the local-file server 100 and the magnetic disk device (storage means) 223A of the remote-file server 200A. This copying process is substantially the same as that of the above-mentioned first embodiment, and the initial copying process and the differential copying process are carried out. Further, under the control of the duplication means 224, the data stored in the magnetic disk device 223A is regularly copied to the magnetic disk device 223B in a substantially real-time manner.

At a certain timing during this duplication process, the duplication means 224 interrupts the duplication process. In this interrupted state, the remote-copying means 222 of the remote-file server 200A sends the data stored in the magnetic disk device 223B to the remote-file server 200B. In this way, a copying process substantially similar to the above-mentioned first embodiment is carried out between the remote-file server 200A and the remote-file server 200B. In this case, the remote-file server 200A will bear the functions of the local-file server 100 in the first embodiment.

Note that the copying process between the local-file server 100 and the magnetic disk device 223A of the remote-file server 200A may be continued even during the duplication-interrupted state. During the interrupted state, differential information of data between the magnetic disk device 223A and the magnetic disk device 223B will be managed and recorded by the remote-copying means 222. When the copying process between the remote-file server 200A and the remote-file server 200B is finished and the duplication-interrupted state is cleared, the duplication process from the magnetic disk device 223A to the magnetic disk device 223B is restarted based on the managed differential information.

Above, some aspects of the present invention have been specifically explained according to the first through third embodiments. However, the present invention is not to be limited to the specific embodiments, and various modifications which do not exceed the scope of the invention may be made.

According to the present embodiments, in carrying out a copying process of data in the local-file server (primary storage system) to the remote-file server (secondary storage system), the copying process is carried out directly between the respective storage devices (storage apparatuses) via the private line 500 (communication line), without involving each of the file servers 110, 210 (control apparatuses). Thus, the file servers 110, 210 do not have to carry out a process of reading out data from the storage devices, thereby reducing load of the servers and also realizing speed up of the copying process. Additionally, since the copying process is carried out without using the network such as a LAN or a WAN to which a client is connected, the copying process can be performed immediately without causing any delay even when the file servers 110, 210 are carrying out other processes.

Although the preferred embodiment of the present invention has been described in detail, it should be understood that various changes, substitutions and alterations can be made therein without departing from spirit and scope of the inventions as defined by the appended claims.

What is claimed is:

1. A computer system comprising:
a computer;
a primary file server coupled to the computer, the primary file server executing a file system function for managing files accessed from the computer;
a primary storage apparatus coupled to the primary file server, the primary storage apparatus having a primary volume, the primary volume including:
a data area storing data associated with the files; and
a metadata area storing metadata indicating locations on the data area associated with the files; and
a secondary storage apparatus coupled to the primary storage apparatus, the secondary storage apparatus having a secondary volume,
wherein the primary file server reads the metadata from the primary volume, identifies first locations on the data area associated with the files based on the metadata, and sends data transfer instructions designating the first locations on the data area and second locations indicating the metadata area,
wherein the primary storage apparatus receives the data transfer instructions, and sends data in the primary volume according to the data transfer instructions, and
wherein the secondary storage apparatus stores the metadata and a portion of the data stored in the data area associated to the files, into the secondary volume, according to the data sent from the primary storage apparatus.

2. The computer system of claim 1, wherein the locations indicated by the metadata are pointers.

3. The computer system of claim 1, wherein the metadata stores file sizes and access authority information of the files.

4. The computer system of claim 3, wherein the metadata stores last-updated times.

5. The computer system of claim 1, further comprising:
a secondary file server providing a file access with the secondary volume.

6. A file server coupled to a computer and a primary storage apparatus, the file server comprising:
a first interface coupled to the computer;
a second interface coupled to the primary storage apparatus; and
a processor executing a file system function for managing files accessed from the computer, and accessing a primary volume in the primary storage apparatus, the primary volume including:
a data area storing data associated to the files; and
a metadata area storing metadata indicating locations on the data area associated to the files,
wherein the file server reads the metadata from the primary volume, identifies first locations on the data area associated to the files based on the metadata, and sends, to the primary storage apparatus, data transfer instructions designating the first locations on the data area and second locations indicating the metadata area, the data transfer instructions being used by the primary storage apparatus to copy the metadata and data associated to the files from the primary storage apparatus to a secondary storage apparatus.

7. The file server of claim 6, wherein the locations indicated by the metadata are pointers.

8. The file server of claim 6, wherein the metadata stores file sizes and access authority information of the files.

9. The file server of claim 8, wherein the metadata stores last-updated times.

10. A file copy method in a computer system, the method comprising:
executing, at a file server in the computer system, a file system function for managing files accessed from a computer;
managing a primary volume of a primary storage apparatus in the computer system, the primary volume including a data area storing data associated to the files and a metadata area storing metadata indicating locations on the data area associated to the files;
reading, at the file server, the metadata from the primary volume;
identifying, at the file server, first locations on the data area associated to the files based on the metadata;
sending, from the file server, data transfer instructions designating the first locations on the data area and second locations indicating the metadata area; and
copying, according to the data transfer instructions, the metadata and a portion of the data stored in the data area associated to the files to a secondary volume of the secondary storage apparatus.

11. The method of claim 10, wherein the locations indicated by the metadata are pointers.

12. The method of claim 10, wherein the metadata stores file sizes and access authority information of the files.

13. A method of claim 12, wherein the metadata stores last-updated times.
